(19) United States
(12) Patent Application Publication
(10) Pub. No.: US 2004/0140189 A1
(43) Pub. Date: Jul. 22, 2004

(54) Operating device for an electric switch comprising a push-button

(76) Inventor: Roland Ruegenberg, Bad Sobernheim (DE)

Correspondence Address: JACOBSON HOLMAN PLLC, 400 SEVENTH STREET N.W., SUITE 600, WASHINGTON, DC, 20004, US

(21) Appl. No.: 10/477,199

(22) PCT Filed: May 15, 2002
(86) PCT No.: PCT/DE02/01740

(30) Foreign Application Priority Data
May 15, 2001 (DE) 101 23 536.4

(51) Int. Cl. H01H 3/12

(52) U.S. Cl. 200/341

(57) ABSTRACT

The invention relates to an operating device (1) comprising a rotatable crank drive which can be actuated by repeatedly pressing and releasing a push-button (4). The push-button (4) is thus alternately fixed in an operating position, i.e. the out position, and a locking position, i.e. the pressed-in position. A rotatable locking ring (9) which can be axially displaced in an elastic manner and the housing (8) of the operating device (1) comprise crank elements (10, 11) which are alternately distributed around the circumference, and in which the push-button (4) can be securely locked in a precise position.

The invention relates to an operating device for a flush operating knob with a locking device for the axial locking and unlocking of the operating knob that is extendable under spring load by means of a link guide, especially for the rotary switch of an automobile.

It is common to flush-mount rotary knobs, such as those for the adjustment of brightness of lighting devices, in the instrument panel, and to release them from their home position by means of a simple push of the knob in order to activate the operating knob. The knob is then flush again by simply pushing it in, and locked in this position in order to hamper any unintentional activation and adjustment.

Generally, such devices, such as those according to DE 4330502 A, are provided with a stationary link component, in the cardioid of which a laterally traveling link pin, which is connected to the spring-loaded operating knob, engages in such a way that the axial position of the operating knob changes cycles by means of simply pressing between two different stroke positions. All stops and guides are embodied on the body, which appropriately must be designed in a complex and stable manner.

The invention is based on the task of increasing locking safety, and improving the bearing of the movable components of the operating device.

This task is solved by means of the characteristics provided in claim 1.

Such rotatory link drives are generally known to have push button switches, which change the switching position in gradual cycles, whereby the actual adjustment of the switch is directly activated by pressing the push knob once or several times. A rotating link component is gradually rotated in a defined manner. The same is kinematically connected to active switching elements. In this way, different switching positions can be realized in the various rotary positions of the link component.

The uses of such a drive for the mere purpose of locking and unlocking according to the invention has the advantage that a multitude of support positions can be created along the circular track at the stationary link surfaces, on which the multiple link elements, which are assigned to the push knob, are supported on a broad basis with a correspondingly high input tension. This causes the push knob to be safely fixed in its height position and its axial angular position, without requiring an exact guide inside of the body for this purpose. The lateral buckling of the push knob is thereby reliably avoided. The exterior side of the knob can be maintained in a center position in an opening of the instrument panel without any lateral offset. By means of the large support and gliding panes of the link drive, materials of low strength and improved gliding properties can be utilized.

Advantageous further embodiments of the invention are included in the characteristics of claims 2 to 5.

The embodiment according to claim 2 fixes the push knob in a manner that is safe from buckling.

The embodiments according to claims 3 and 4 result in a simple, stable, and easy to produce design, whereby an interior molded component can be embodied of two molded inserts that are divided lateral in the direction of the axis.

Using the characteristics of claim 5, the push knob can be supported free of clearance in its extended state under input tension at a defined height position on the instrument panel, without the body having to be precisely fixed on the instrument panel. This simplifies the configuration of the operating device, as well as its assembly inside of the instrument panel. This procedure is benefited by the fact that the push knob can be anchored particularly safely in its pushed-in position with the aid of the multiple link elements so that the risk of any unintentional unlocking with parts possibly catapulting off is negligible.

An embodiment example of the invention is illustrated in the drawing, and is explained in further detail as follows. It shows:

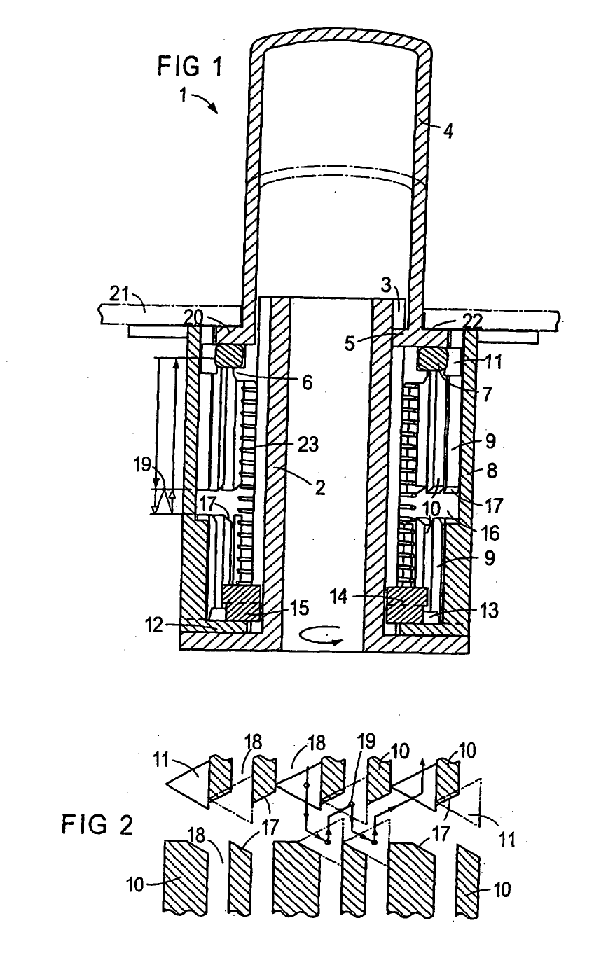

FIG. 1A longitudinal section through an operating device with circular distributed link elements,

FIG. 2 Schematically, a partial contact arrangement of the link elements according to FIG. 1 in various positions of a movement cycle.

According to FIG. 1, an operating device 1 has a central, axially fixed rotor 2 for driving a not illustrated rotary instrument that is positioned underneath. The rotor is equipped with exterior longitudinal notches 3, into which a bonnet-shaped push knob 4 with at least one catcher 5, which protrudes into the interior, engages in an axially relocatable and pivot-proof manner. On the bottom side of the push knob 4, a multitude of axially protruding, circular distributed snap hooks are attached, which face the exterior, and on which a locking ring 7 is axially fixed and pivoted.

The rotor 2 is received in a cylinder-shaped body 8, on the interior wall of which circumferentially distributed longitudinal ligaments 9 are molded, which are embodied in a center section as fixed link elements 10 of a rotatory link drive. The locking ring 7 has cam-like movable link elements 11 that protrude toward the exterior in a circular distribution, which engage between the fixed link elements 10, and together with the same, form the link drive. The longitudinal ligaments 9 are interrupted in the center section, and release a ring-shaped circumferential track 16 for the movable link elements 11. At a lower bottom 12 of the body 8, a circumferential cam track is molded with cams 13 that reach toward the top. At this height, the rotor 2 is pivot-proof and axially relocatably surrounded by a latch ring 14 with latch cams 15 that protrude toward the bottom, which engage between the cams 13 in a ratchet-like manner. A coil pressure spring 23 is rigged between the lower latch ring 14 and the upper latch ring 6, which pushes the latch ring 14 toward the bottom, and the push knob 4 toward the top with a collar-like stop 20 against a stop shoulder 22 of an instrument panel 21 indicated by semi-colon lines.

In the position shown, the push knob 4 is pushed out of the flush latch position indicated by semi-colon lines into an operating position, in which it may be grabbed by the hand and adjusted. This adjustment is-under the ratchet effect of the latch ring 14-transferred to the rotor 2, and from the rotor, for example, to a not illustrated rotary potentiometer for the adjustment of the luminous intensity. Subsequently, the push knob 4 can be relocated into the area of the circumferential track 16 by picking up the circularly fixed locking ring 7.

According to FIG. 2, the fronts of the longitudinal ligaments 9 that face each other have accumulation chamfers 17, which are aligned with corresponding counter chamfers of the trapeze-shaped movable link elements 11 of the locking ring 7 in such a way that the same are relocated into the same direction when the accumulation chamfers 17 are pushed. The longitudinal ligaments 9 arranged above the circumferential track 16 are offset and arranged at a clearance with respect to the bottom ones so that the movable locking elements 11 are safely rotated into the contact range of the respective next fixed locking element 10 by successively pushing and releasing the push knob 4.

Narrower and broader channels 18 are successively released between the upper longitudinal ligaments 9 as the movable link elements 11, which, in the broader ones can be relocated to the upper operating position, and which can rest at the narrower ones in the locking position 19. The different intermediate positions are marked by the link elements 11 indicated by the semi-colon lines, the movement track of which is indicated by the movement arrows.

### Reference Symbols

1 operating device

2 rotor

3 longitudinal notch

4 push knob

5 catcher

6 latch hook

7 locking ring

8 body

9 longitudinal ligament

10 fixed link element

11 movable link element

12 bottom

13 cams

14 latch ring

15 latch cams

16 circumferential track

17 accumulation chamfer

18 channel

19 locking position

20 stop

21 instrument panel

22 stop shoulder

23 coil pressure spring

1. Operating device (1) for a flush operating knob (4) with a locking device for the axial locking and unlocking of the operating knob (4) that is extendable under spring load by means of a link guide, especially for the rotary switch of an automobile,
characterized in that the link guide is embodied as a multiple toothed, circumferential link drive,
that a body (8) of the operating device (1), and a locking ring (9) that is axially fixed and pivoted on the operating knob (4) have successively arranged, circumferentially distributed link elements (10 and 11), in which the operating knob (4) can be axially locked.

2. Operating device according to claim 1,
characterized in that the locking ring (9) has at least three of the movable link elements (11) that are equally distributed across its circumference, which are supported in the locking position on the fixed link elements (10) of the body (8).

3. Operating device according to claims 1 or 2,
characterized in that the fixed link elements (10) are attached at an essentially hollow-cylindrical wall of the body (8) radially facing toward the interior, and
that the movable link elements (11) of the locking ring (9) protrude radial toward the exterior, and engage into the fixed link elements (10).

4. Operating device according to claims 1, 2, or 3,
characterized in that the fixed link elements (10) are embodied of upper longitudinal ligaments (9), and offset from the same of lower longitudinal ligaments (9) with frontal accumulation chamfers (17) that face each other,
and that the width of the upper longitudinal ligaments (9) each correspond to the width of the channels (18) embodied between the lower longitudinal ligaments (9), and vice versa.

5. Operating device according to one of the previous claims,
characterized that the fixed link elements (10) of the body (8) continuously extend to an exterior body edge of the hollow-cylindrical wall,
that the operating device (1) can be attached to an assembly area in an instrument panel (21) in its locked position, and that the axial spring-loaded operating knob (4) in its unlocked position can be pushed a stop shoulder (22) of the instrument panel (21) against a collar-like stop (20).
